(19) United States
(12) Patent Application Publication
(10) Pub. No.: US 2024/0056411 A1
(43) Pub. Date: Feb. 15, 2024

(54) ADDRESS RESOLUTION SERVICE

(71) Applicant: MELLANOX TECHNOLOGIES, LTD., Yokneam (IL)

(72) Inventors: Gal Shalom, Givat Avni (IL); Adi Horowitz, Tel Aviv (IL); Jonatan Piasetzky, Tel Aviv (IL); Omri Kahalon, Tel Aviv (IL); Matty Kadosh, Hedera (IL); Aviad Shaul Yehezkel, Yokneam Ilit (IL); Rabia Loulou, Nazareth (IL); Liran Liss, Atzmon-Segev (IL)

(21) Appl. No.: 17/884,057

(22) Filed: Aug. 9, 2022

(51) Int. Cl. H04L 61/103; H04L 61/2503; H04L 61/10

(52) U.S. Cl. CPC H04L 61/103; H04L 61/2503; H04L 61/10

(57) ABSTRACT

System, methods, and devices for providing an address resolution service are provided. In one example, an Address Resolution Service (ARS) node is described as being in communication with one or more endpoints. The ARS node may include one or more circuits that respond to an ARS query message issued by the one or more endpoints with a response message that translates a layer three address to a layer two address.

### FIELD OF THE DISCLOSURE

The present disclosure is generally directed toward networking and, in particular, toward address resolution services provided within a communication network.

### BACKGROUND

A connection between two endpoints in a communication network is often achieved according to each endpoint's layer three (L3 or network layer) address, but the layer two (L2 or data link) address should be used and known as well. An Internet Protocol (IP) address is an example of a layer three address. A Media Access Control (MAC) address is an example of a layer two address. Because the layer three address is a logical address, the layer three address will be used by a communication protocol. The layer two address corresponds to the actual hardware interface (e.g., a Network Interface Controller (NIC)) in a device. A device can have any number of layer three addresses, but it will only a single layer two address per network interface.

The standard for discovering layer two addresses according to a layer three address is the Address Resolution Protocol (ARP). However, ARP requires the use of broadcast messages, which can flood the network. In a network having N nodes where each nodes sends an ARP broadcast message, the network will experience NA2 packets for the broadcast messages, most of which are not needed. Because ARP is at the base of the Ethernet network stack, the problem occurs frequently. Traditionally, networks are not so large that the use of broadcast messages according to ARP impacts network performance. As networks grow and the number of endpoints within a network grow, the cost of NA2 broadcast messages is becoming more important to mitigate.

### BRIEF SUMMARY

Embodiments of the present disclosure aim to improve network performance by defining a new address resolution approach. In particular, embodiments of the present disclosure provide an Address Resolution Service (ARS), which uses N broadcast messages as compared to the N\hat{ }2 broadcast messages used within ARP. Deployment of an ARS approach as described herein will help to mitigate network flooding that might occur if N\hat{ }2 broadcast messages were transmitted during address resolution according to ARP.

Illustratively, and without limitation, a networking device is disclosed herein to include: a processor and memory coupled with the processor, where the memory includes data that, when processed by the processor, enables the processor to: receive an Address Resolution Service (ARS) query message from an endpoint, where the ARS query includes a request for an address translation; reference a lookup table for a first address included in the ARS query message; identify, based on information in the lookup table, that the first address is associated with a second address; and provide the endpoint with a response to the ARS query message that includes the second address as a translation for the first address.

In some embodiments, the lookup table is maintained in the memory.

In some embodiments, the lookup table includes an Internet Protocol (IP) address field, a Media Access Control (MAC) address field, a timestamp field, and a reply failures field.

In some embodiments, the first address corresponds to an IP address, the second address corresponds to a MAC address, and the lookup table maps the IP address to the MAC address.

In some embodiments, the timestamp field includes data describing a time at which to broadcast an ARS Who message to at least one other ARS node.

In some embodiments, the reply failures field includes data describing a maximum number of reply failures to accept before responding to the ARS query message with an error message.

In some embodiments, the first address includes a layer three address and the second address includes a layer two address.

In some embodiments, the memory includes additional data that, when processed by the processor, enables the processor to: broadcast an ARS Who message in response to referencing the lookup table and determining that the lookup table does not initially include the first address therein; receive a response to the ARS Who message from at least one other endpoint; and update the lookup table to include the first address and additional information contained in the response to the ARS Who message.

In some embodiments, the memory includes additional data that, when processed by the processor, enables the processor to: synchronize the lookup table with another lookup table of at least one other ARS node.

In some embodiments, the response to the ARS query message includes a unicast message.

In another example, a system is disclosed herein to include: at least one Address Resolution Service (ARS) node in communication with one or more endpoints, where the at least one ARS node includes a lookup table that translates layer three addresses to layer two addresses, and where the at least one ARS node responds to an ARS query message from the one or more endpoints by referencing the lookup table for a first address included in the ARS query message, identifying that the first address is associated with a second address, and transmitting a response to the ARS query message that includes the second address as a translation for the first address.

In some embodiments, the first address includes a layer three address and the second address includes a layer two address.

In some embodiments, the at least one ARS node issues a broadcast message on behalf of the one or more endpoints.

In some embodiments, the at least one ARS node updates the lookup table with information received in a response to the broadcast message.

In some embodiments, the at least one ARS node synchronizes the lookup table with a lookup table of another ARS node.

In some embodiments, the at least one ARS node is stateless and maintains the lookup table independently.

In another example, an Address Resolution Service (ARS) node is disclosed as being in communication with one or more endpoints, the ARS node including: one or more circuits that respond to an ARS query message issued by the one or more endpoints with a response message that translates a layer three address to a layer two address.

In some embodiments, the one or more circuits maintain a lookup table that is stateless and maintained independent of other lookup tables maintained by other ARS nodes.

In some embodiments, the layer three address is included in the ARS query message, the one or more circuits reference the lookup table for the layer three address, and the one or more circuits include the layer two address in the response message based on the reference to the lookup table.

In some embodiments, the one or more circuits update the lookup table by issuing a broadcast message on behalf of the one or more endpoints.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram illustrating a computing system in accordance with at least some embodiments of the present disclosure;

FIG. 2 is a block diagram illustrating a data structure used within a lookup table in accordance with at least some embodiments of the present disclosure;

FIG. 3 is a flow diagram illustrating a method of requesting an address resolution service in accordance with at least some embodiments of the present disclosure;

FIG. 4 is a flow diagram illustrating a method of responding to a request for an address resolution service in accordance with at least some embodiments of the present disclosure;

FIG. 5 is a flow diagram illustrating a method of updating a lookup table in accordance with at least some embodiments of the present disclosure; and

FIG. 6 is a flow diagram illustrating another method of updating a lookup table and/or responding to a request for an address resolution service in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a Printed Circuit Board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

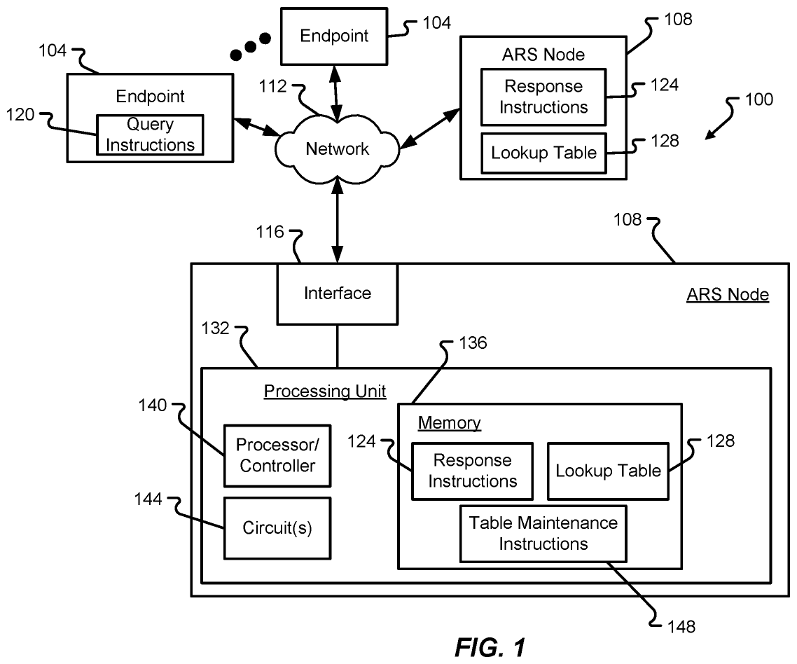

Referring now to FIGS. 1-6, various systems and methods for providing address resolution services will be described in accordance with at least some embodiments of the present disclosure. As will be described in more detail herein, an address resolution service is provided that is capable of using O(N) broadcast messages to facilitate address resolution. In some embodiments, the proposed address resolution protocol described herein employs one or more dedicated entities (e.g., ARS nodes) to answer for address resolution requests. The dedicated entities may be provided with a local (or locally-available) lookup table which serves all nodes on the subnet. Such a configuration can save redundant broadcasts that are issued when traditional protocols, such as ARP, are employed. While embodiments will be described in connection with L3-to-L2 translations, it should be appreciated that the address resolution services described herein can be used in connection with other types of address translations.

Referring initially to FIG. 1, an illustrative system 100 is shown in which endpoints 104 are connected to one another via a communication network 112. The system 100 may also include one or more ARS nodes 108, which help facilitate address translation functions and provide address resolution services to the one or more endpoints 104. While illustrated as different types of devices, it should be appreciated that the endpoint 104 and ARS node 108 may be a similar type of device, but may have different roles or capabilities within the system 100. For instance, the endpoints 104 and/or ARS nodes 108 may correspond to any suitable type of computing device, network device, or the like that include processors, computer memory, network interfaces, etc.

In some embodiments, the address resolution services described herein may employ an architecture where two different kinds of entities exist: (1) an endpoint 104 and (2) an ARS node 108. An endpoint 104 may correspond to any device connected to the network 112 that requires a translation between layer three and layer two addresses to facilitate communications with another endpoint 104. Examples of endpoints 104 include, without limitation, routers, hosts, etc. An ARS node 108 corresponds to a device connected to the network 112 that responds to translation requests issued by endpoints 104. Examples of ARS nodes 108 include, without limitation, switches, servers, Network Interface Controllers (NICs), network adapters, etc.

When an endpoint 104 desires to communicate with another endpoint 104 and requires a translation between a layer three and layer two address, the endpoint 104 issues an ARS query message to one or more ARS nodes 108. In some embodiments, the endpoint 104 may issue the ARS query message to a particular and defined ARS node 108. In some embodiments, the endpoint 104 may issue the ARS query message to any or all ARS nodes 108 connected to the network 112. The endpoint 104 may utilize query instructions 120 that are stored in memory as part of generating and issuing an ARS query message. The query instructions 120 may be executable by a processor of the endpoint 104 and may cause the endpoint 104 to generate and transmit the ARS query message to one or more ARS nodes 108 via the network 112. Although not depicted, the endpoints 104 may also include one or more network interfaces that facilitate connectivity with the network 112.

The ARS nodes 108 may also include a network interface 116 that facilitates connectivity with the network 112. An ARS node 108 may also include response instructions 124 and a lookup table 128 that, when executed by a processor 140 of the ARS node 108, enable the ARS node 108 to respond to ARS query messages received from endpoints 104. The response instructions 124 and lookup table 128 may be stored in memory 136 of the ARS node 108. The ARS node 108 may also include a processing unit 132 having one or more processors/controllers 144 as well as one or more circuits 144 that are capable of executing the response instructions 124 along with other instructions stored in memory 136. For instance, an ARS node 108 may also include table maintenance instructions 148 that, when executed by the processor 140, enable the ARS node 108 to maintain, update, or manage the lookup table 128.

As will be described in further detail herein, each ARS node 108 may maintain its own lookup table 128. In some embodiments, the lookup table 128 of one ARS node 108 may be maintained statelessly and independent of other lookup tables maintained by other ARS nodes 108. In some embodiments, the ARS nodes 108 may update their lookup table 128 by issuing a broadcast message on behalf of one or more endpoints 104. In some embodiments, at least one ARS node 108 may synchronize the maintenance of its lookup table 128 with a lookup table 128 of another ARS node 108. Details of lookup tables 128 and the maintenance thereof will be described in further detail herein. Because each ARS node 108 can be stateless, every ARS node 108 may be configured as a standalone node that holds its own translations and its own timeout counters. Again, each ARS node 108 may contain a lookup table 128 which holds L3->L2 translation (where the key is an L3 address and the value is the L2 address). In some embodiments, the ARS node 108 is configured to unicast poll the remote hosts on its lookup entries by periodically sending a unicast ARS IsAlive message and delete the entry if no ARS Alive is received after an number of successive polls.

Endpoints 104 may be configured to transmit some types of messages while ARS nodes 108 may be configured to transmit other types of messages as part of address resolution/translation. Non-limiting examples of ARS message types that may be issued within the system 100 include:
IsAlive
   From ARS node 108 to endpoint 104
   Used by ARS node 108 to do unicast poll (check the L3 is valid)
   An unreliable unicast message Alive
   From endpoint 104 to ARS node 108
   Used by endpoint 104 to reply to the unicast poll (IsAlive message)
   An unreliable unicast message
Query
   From endpoint 104 to ARS node 108
   Used by endpoint 104 to ask for a translation
   An unreliable unicast message
Answer
   From ARS node 108 to endpoint 104
   Used by ARS node 108 to answer for Query
   An unreliable unicast message
Who
   From ARS node 108 to endpoint 104
   Used by ARS node 108 to ask who has the L3 address
   An unreliable broadcast message
Me
   From endpoint 104 to ARS node 108
   Used by endpoint 104 to answer for Who
   An unreliable unicast message
Probe
   Similar to ARP probe: A Query without sender L3 address
Announcement—similar to gratuitous ARP
   From endpoint 104 to all ARS nodes 108
   Used by endpoint 104 to broadcast an address change (Usually L2 address change)
   An unreliable broadcast message

While two endpoints 104 and two ARS nodes 108 are depicted for ease of understanding, it should be appreciated that the system 100 may include a single ARS node 108 or more than two ARS nodes 108. Likewise, the number of endpoints 104 in the system 100 may be greater or fewer than the number of endpoints 104 illustrated.

In some embodiments, the endpoints 104 and/or ARS nodes 108 are provided with a processing unit 132 that is configured to perform data processing functions for the device. As an example, the ARS node 108 may include a processing unit 132 in the form of a Central Processing Unit (CPU), Graphics Processing Unit (GPU), or Data Processing Unit (DPU), which may enable the ARS node 108 to maintain a lookup table 128 and provide address translation services to endpoints 104.

The device interface 116 may enable with the communication network 112 via a communication link. The communication link may include a wired connection, a wireless connection, an electrical connection, etc. In some embodiments, the communication link may facilitate the transmission of data packets between the other devices connected to the network 112. It should be appreciated that the communication link established between the interface 116 and the network 112 may include, without limitation, a PCIe link, a Compute Express Link (CXL) link, a high-speed direct GPU-to-GPU link (e.g., an NVlink), etc.

The memory 136 may include instructions for execution by the processor 140 that, when executed by the processor 140, enable the processing unit 132 to perform any number of tasks (e.g., data routing tasks, data processing tasks, address translation, table maintenance, etc.). In some embodiments, the memory 136 may include the lookup table 128 as well as processor-executable instructions, such as response instructions 124 and table maintenance instructions 148. Although depicted as separate components, the response instructions 124 and table maintenance instructions 148 may be provided in a common instruction set that is used to respond to ARS query messages as well as update the lookup table 128.

While the lookup table 128 will be described as a table, it should be appreciated that any data structure or combination of data structures may be used to provide functions of the lookup table 128 as described herein. In some embodiments, the lookup table 128 may be maintained/stored in the same memory 136 as the response instructions 124. In some embodiments, the lookup table 128 may be maintained/stored in a separate memory device from the memory 136 and may be accessed by the response instructions 124 using a data lookup or data request function. In other words, it helps for computing efficiency to maintain the lookup table 128 relatively near the response instructions 124, but it does not necessarily need to be maintained in the same memory 136 as the response instructions 124.

The one or more circuits 144 may be provided as part of the processor 140 or may be specifically configured to perform a function of the processor 140 without necessarily referencing instructions in memory 136. For instance, the circuit(s) 144 may include digital circuit components, analog circuit components, active circuit components, passive circuit components, or the like that are specifically configured to perform a particular address resolution function and/or table maintenance function. The circuit(s) 144 may alternatively or additionally include switching hardware that is configurable to selectively interconnect one device interface 116 with another device interface 116 (e.g., where the ARS node 108 includes a switch or a component of a switch). Accordingly, the circuit(s) 144 may include electrical and/or optical components without departing from the scope of the present disclosure.

The processor 140 and/or circuit(s) 144 may include one or more Integrated Circuit (IC) chips, microprocessors, circuit boards, simple analog circuit components (e.g., resistors, capacitors, inductors, etc.), digital circuit components (e.g., transistors, logic gates, etc.), registers, Field Programmable Gate Arrays (FPGAs), Application Specific Integrated Circuits (ASICs), combinations thereof, and the like. It should be appreciated that the processor 140 may correspond to an optional component of the processing unit 132, especially in instances where the circuit(s) 144 provide sufficient functionality to support operations of the processing unit 132 described herein. As noted above, the processing unit 132 may correspond to a CPU, GPU, DPU, combinations thereof, and the like. Thus, while only a single processing unit 132 is shown in the ARS node 108, it should be appreciated that the ARS node 108 may include multiple processing units 132 without departing from the scope of the present disclosure.

The memory 136 may include any number of types of memory devices. As an example, the memory 136 may include Random Access Memory (RAM), Read Only Memory (ROM), flash memory, Electronically-Erasable Programmable ROM (EEPROM), Dynamic RAM (DRAM), buffer memory, combinations thereof, and the like.

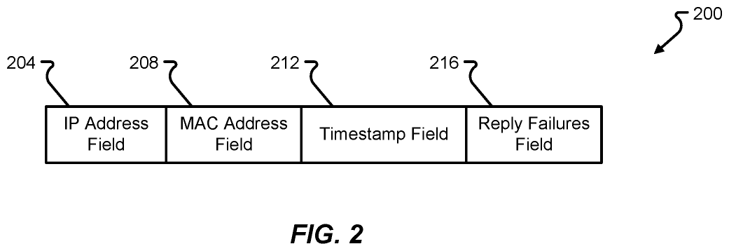

With reference now to FIG. 2, additional details of the lookup table 128 and data that may be stored therein will be described in accordance with at least some embodiments of the present disclosure. The lookup table 128 may be configured to store one or more data structures 200 that can be referenced during an address translation operation.

In some embodiments, the data structure 200 may include an IP address field 204, a MAC address field 208, a timestamp field 212, and a reply failures field 216. The size and/or amount of data stored within each field can vary depending upon design preferences or constraints. In some embodiments, the IP address field 204 may be sufficiently sized to store an IP address or similar type of layer three address. In some embodiments, the IP address field 204 may be configured to store a logical address in a known address format. As an example, the IP address field 204 may be configured to store at least 32 bits, since IPv4 addresses are normally 32-bit numbers.

In some embodiments, the MAC address field 208 may be sufficiently sized to store a MAC address or similar type of layer two address. In some embodiments, the MAC address field 208 may be configured to store a physical address in a known address format. As an example, the MAC address field 208 may be configured to store at least 48 bits. When a first address is stored in the IP address field 204 and a second address is stored in the same row within the MAC address field 208, an association may be made between the first address and second address (e.g., the second address, which is a layer two address, can be provided as a translation for the first address, which is a layer three address). Said another way, storage of addresses in a common row may allow the response instructions 124 to know that the addresses are associated with one another and can be provided as a translation for one another. Thus, when an ARS query message is received with a first address that is found in the IP address field 204, the response instructions 124 can identify an associated second address in the same row as the first address (stored within the MAC address field 208) and respond to the ARS query message with the second address.

The timestamp field 212 may be configured to store data describing a time at which to poll an endpoint using an ARS IsAlive message. As will be discussed in further detail herein, an ARS IsAlive message can be used by an ARS node 108 to check the validity of a row entry. In some embodiments, the timestamp field 212 may include a reference to a timer that, upon expiration, triggers the table maintenance instructions 148 to issue a new ARS IsAlive message. In some embodiments, the timestamp field 212 may be sufficient sized to store time data, a counter, or a pointer to time data maintained at another location in memory 136.

The reply failures field 216 may be configured to store data describing a maximum number of reply failures that the ARS node 108 will accept before responding to an ARS query message with an error message. The reply failures field 216 may be sufficiently sized to store an integer number that is referenced as a threshold by the response instructions 124. The response instructions 124 may issue one or more ARS Who messages if an ARS query message contains a first address that is not within the local lookup table 128. The data stored in the reply failures field 216 may be referenced each time the response instructions 124 attempt sending a new ARS Who message such that when the number of attempts meets or exceeds the threshold stored in the reply failures field 216, the response instructions 124 will not issue another ARS Who message, but will instead respond to the endpoint 104 that transmitted the ARS query message with an error message. The reply failure may also indicate when to declare an entry invalid—if more than a predetermined number of unanswered IsAlive messages are sent (e.g., the number of unanswered messages exceeds a predetermined threshold), the MAC address translation is considered invalid/incorrect.

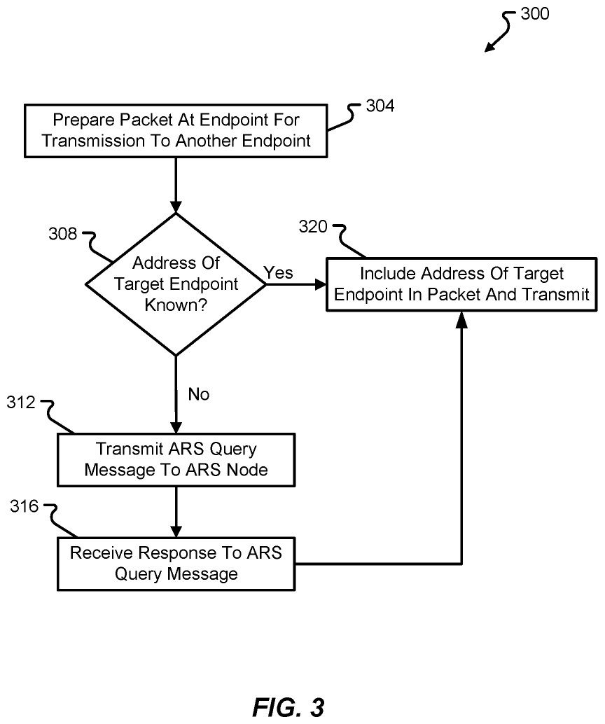

Referring now to FIGS. 3-6, additional details regarding operations of components in the system 100 will be described. While certain steps of the methods will be described as being performed in a particular order and by a particular component, it should be appreciated that embodiments of the present disclosure are not so limited. Specifically, the order of operations in the various methods may be modified and any component or combination of components in the system 100 may be configured to perform some or all of the method steps depicted and described herein.

Referring to FIG. 3, a method 300 of requesting an address resolution service will be described in accordance with at least some embodiments of the present disclosure. The method 300 begins with an endpoint 104 preparing one or more packets for transmission to another endpoint 104 (step 304). This step may be triggered in response to the endpoint 104 receiving a packet or information that it is forwarding along to the next endpoint 104. Alternatively or additionally, the step may be triggered in response to the endpoint 104 receiving an instruction (from a user or from another machine) to communicate with another endpoint 104.

The method 300 will continue with the endpoint 104 determining if address(es) of the target endpoint 104 are known (step 308). If the address(es) (e.g., layer two and layer three) of the destination or target endpoint 104 are known to the initiating endpoint 104, then the endpoint 104 may simply generate and send the packet(s) to the target endpoint 104 (step 320). If, however, the endpoint 104 does not know at least one address (e.g., a layer two address) of the target endpoint 104, then the method 300 may continue with the endpoint 104 invoking the query instructions 120 to transmit an ARS query message to one or more ARS nodes 108 (step 312). The ARS query message is effectively a request made by the endpoint 104 to have the ARS node 108 perform an address translation (e.g., L3-> to->L2) on behalf of the endpoint 104. The ARS query message may only be transmitted to one or more ARS nodes 108 known to the endpoint 104. In other words, the ARS query message may not be broadcast to all devices connected to the network 112, thereby minimizing the impact on the network 112 that would otherwise be introduced if all endpoints 104 were broadcasting ARS query messages to all other devices on the network 112.

After the ARS query message is transmitted, the endpoint 104 will wait for a response to the ARS query message. Specifically, the endpoint 104 may wait for a predetermined amount of time or may wait for a particular event. The method 300 may continue when a response to the ARS query message is received from an ARS node 108 (step 316). With the address information now available at the endpoint 104 the method 300 continues to step 320 where the endpoint 104 includes the address(es) of the target endpoint 104 in the packet(s) and transmits the packet(s) across the network 112.

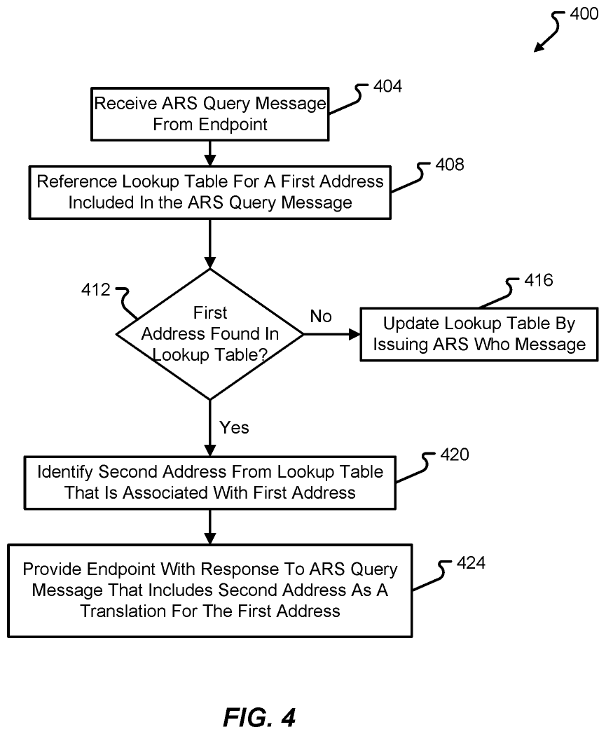

With reference now to FIG. 4, a method 400 of responding to a request for an address resolution service will be described in accordance with at least some embodiments of the present disclosure. The method 400 is initiated when an ARS query message is received at an ARS node 108 from an endpoint 104 (step 404). The ARS query message may be received at an interface 116 or within a processing unit 132 of the ARS node 108. In some embodiments, the ARS query message may include a layer three address that the endpoint 104 desires to have translated to a layer two address.

Upon arrival of the ARS query message, the ARS node 108 may invoke the response instructions 124 to check the lookup table 128 for the address contained in the ARS query message (step 408). In particular, the response instructions 124 may search the lookup table 128 using the layer three address that was included in the ARS query message. If the address in the ARS query message is found (step 412), then the response instructions 124 will obtain a second address that is associated with the address from the ARS query message (step 416). For example, the response instructions 124 may identify a layer two address that is associated with the layer three address from the ARS query message based on referencing the lookup table 128.

The response instructions 124 will then provide the endpoint 104 with a response to the ARS query message (step 424). In some embodiments, the response may include the second address as a translation for the first address that was originally provided in the ARS query message. In some embodiments, the response may be provided to the endpoint 104 via a unicast ARS answer message.

As will be described in further detail herein, if the first address from the ARS query message is not found in the lookup table 128, then the response instructions 124 may initiate a process of discovering or searching for the address(es) of the endpoint 104 identified by the first address. In some embodiments, the response instructions 124 in concert with the table maintenance instructions 148 may perform a process of broadcasting one or more ARS Who messages to other endpoints 104 and/or ARS nodes 108 in the network 112. A response to the one or more ARS Who messages may be used to update the lookup table 128, which can then be used by the response instructions 124 to provide a response back to the ARS query message. In some embodiments, the response to the ARS query message may be provided in the form of an ARS Answer message. If the ARS node 108 issues more than a predetermined number (e.g., as constrained by the threshold value stored in the reply failures field 216) of ARS Who messages when trying to find the first address, then the ARS node 108 may give up the address discovery process and may respond to the endpoint 104 with an error message. Further details of such a process will now be described.

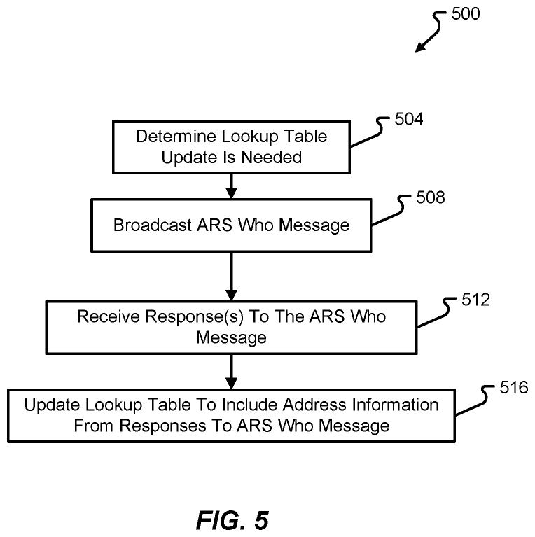

Referring now to FIG. 5, a method 500 of updating a lookup table 128 will be described in accordance with at least some embodiments of the present disclosure. The method 500 begins by determining that the lookup table 128 needs to be updated (step 504). The determination made in step 504 may occur if the response instructions 124 are unable to find an address in the lookup table 128 that was provided by an endpoint 104 in an ARS query message. Alternatively or additionally, the determination made in step 504 may occur if the table maintenance instructions 148 automatically determine that the lookup table 128 has not been updated in at least a predetermined amount of time, in which case an automated table update process is initiated. Alternatively or additionally, the determination made in step 504 may occur if a new endpoint 104 is detected as being connected to the network 112 by the ARS node 108.

The method 500 continues with the ARS node 108 broadcasting an ARS Who message (step 508). The ARS Who message may be broadcast to all devices connected to the network 112 or may be broadcast to just a subset of devices connected to the network 112.

The method 500 may further continue when the ARS node 108 receives one or more responses to the ARS Who message (step 512). In some embodiments, the response to the ARS Who message may be in the form of an ARS Me message, which contains a layer three and/or layer two address of the responding device. It should be appreciated that the responding device may include an endpoint 104 and/or an ARS node 108.

Upon receiving the response to the ARS Who message, the table maintenance instructions may update the lookup table 128 to include address information from the response(s) to the ARS Who message (step 516). As can be appreciated, the table maintenance instructions 148 may also notify the response instructions 124 that the lookup table 128 has been updated, which may allow the response instructions 124 to respond to an ARS query message, if the table update was triggered in response to receiving an ARS query message that had an unrecognized layer three address contained therein.

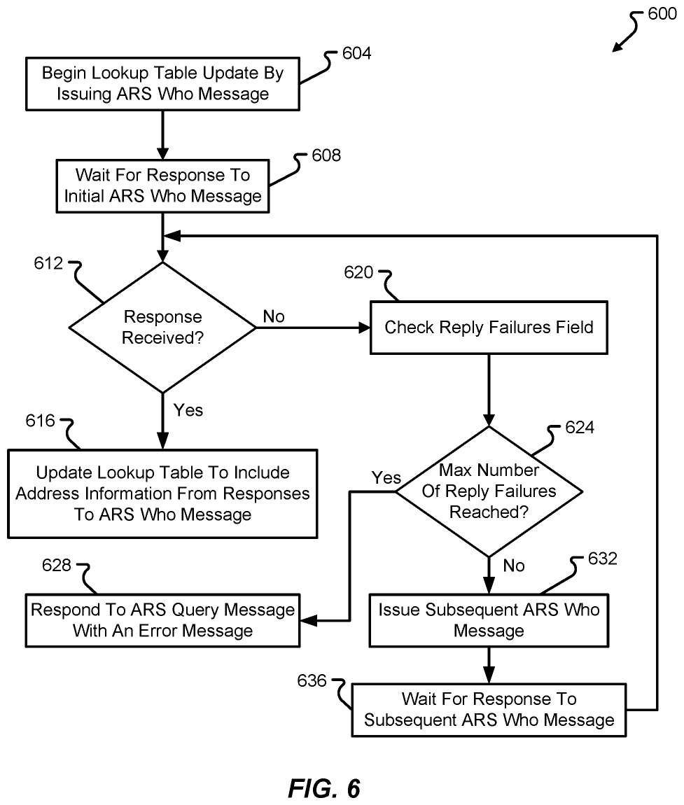

With reference now to FIG. 6, a method 600 of updating a lookup table 128 and/or responding to a request for an address resolution service will be described in accordance with at least some embodiments of the present disclosure. The method 600 includes beginning a lookup table 128 update by issuing an ARS Who message (step 604). This particular step may be similar to step 504.

The method 600 continues with the ARS node 108 waiting for a response to the initial ARS Who message (step 608). In some embodiments, the ARS node 108 may wait for a predetermined amount of time (e.g., T time). The method 600 continues by determining if a response has been received (step 612). This determination may occur positively when a response is received or may occur negatively after the predetermined amount of time has passed and no response has been received.

If the query of step 612 is answered positively, then the lookup table 128 may be updated to include address information from the response(s) (step 616). For example, the lookup table 128 may be updated to include the layer two address from the ARS Me message that was received in response to the ARS Who message. Although not depicted and as described above, after the lookup table 128 has been updated, the method 600 may also include transmitting a response to an ARS query message with information received in the response to the ARS Who message. As a non-limiting example, if the ARS node 108 was able to discover a layer two address for an endpoint 104 that was identified by a layer three address in the ARS query message, the ARS node 108 may respond to the ARS query message with the layer two address of the endpoint 104. It should be appreciated that the response may occur before, simultaneous, or after the lookup table 128 has been updated.

If the query of step 612 is answered negatively, the method 600 may continue by checking the reply failures field 216 (step 620). If the maximum number of reply failures has been reached (step 624), then the ARS node 108 may respond to an outstanding ARS query message with an error message (step 628). Said another way, if the lookup table 128 is being updated in response to an ARS query message that contained a layer three address, but the ARS node 108 is unable to identify an endpoint 104 having the layer three address (and thus cannot find the associated layer two address), the ARS node 108 may consider the layer three address as invalid for a period of time. The ARS node 108 may ignore the ARS query message for the layer three address for the period of time or may respond to the endpoint 104 with an error message.

Referring back to step 624, if the maximum number of reply failures as indicated in the reply failure field 216 has not been reached, then the method 600 may continue with the ARS node 108 issuing a subsequent ARS Who message (step 632). The ARS node 108 may then wait for a response to the subsequent ARS Who message, much like as in step 608 (step 636). The method 600 may then proceed to step 612 where it is again determined if a response to the subsequent ARS Who message has been received.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. A networking device, comprising:
a processor; and
memory coupled with the processor, wherein the memory comprises data that, when processed by the processor, enables the processor to:
receive an Address Resolution Service (ARS) query message from an endpoint, wherein the ARS query comprises a request for an address translation;
reference a lookup table for a first address included in the ARS query message, wherein the lookup table comprises a reply failures field comprising data describing a maximum number of reply failures the networking device will accept before responding to the ARS query message with an error message;
reference the reply failures field to confirm a number of ARS Who messages sent in response to receiving the ARS query message is no larger than the maximum number of reply failures;
in response to confirming that the number of ARS Who messages sent in response to receiving the ARS query message is no larger than the maximum number of reply failures, broadcasting an ARS Who message to solicit a response from at least one other endpoint;
receive the response to the ARS Who message from the at least one other endpoint;
identify, based on information in the lookup table and information contained in the response to the ARS Who message, that the first address is associated with a second address; and
provide the endpoint with a response to the ARS query message that includes the second address as a translation for the first address.

2. The networking device of claim 1, wherein the lookup table is maintained in the memory.

3. The networking device of claim 1, wherein the lookup table further comprises an Internet Protocol (IP) address field, a Media Access Control (MAC) address field, and a timestamp field, and wherein the data included in the reply failures field is referenced every time before sending another ARS Who message.

4. The networking device of claim 3, wherein the first address corresponds to an IP address and wherein the second address corresponds to a MAC address and wherein the lookup table maps the IP address to the MAC address.

5. The networking device of claim 3, wherein the timestamp field comprises data describing a time at which to broadcast an ARS Who message to at least one other ARS node.

6. The networking device of claim 1, wherein the reply failures field also indicates to declare an entry invalid if more than a predetermined number of unanswered IsAlive messages are sent by the networking device.

7. The networking device of claim 1, wherein the first address comprises a layer three address and wherein the second address comprises a layer two address.

8. The networking device of claim 1, wherein the memory comprises additional data that, when processed by the processor, enables the processor to:
update the lookup table to include the first address and the information contained in the response to the ARS Who message.

9. The networking device of claim 1, wherein the memory comprises additional data that, when processed by the processor, enables the processor to:
synchronize the lookup table with another lookup table of at least one other ARS node.

10. The networking device of claim 1, wherein the response to the ARS query message comprises a unicast message.

11. A system, comprising:
at least one Address Resolution Service (ARS) node in communication with one or more endpoints, wherein the at least one ARS node comprises a lookup table that translates layer three addresses to layer two addresses, and wherein the at least one ARS node responds to an ARS query message from the one or more endpoints by referencing the lookup table for a first address included in the ARS query message, identifying that the first address is associated with a second address, and transmitting a response to the ARS query message that includes the second address as a translation for the first address, wherein the lookup table comprises a reply failures field comprising data describing a maximum number of reply failures the at least one ARS node will accept before responding to the ARS query message with an error message, and wherein the data included in the reply failures field is referenced every time before the at least one ARS node broadcasts an ARS Who message in response to receiving the ARS query message to ensure a number of ARS Who messages broadcast in response to receiving the ARS query message does not exceed the maximum number of reply failures.

12. The system of claim 11, wherein the first address comprises a layer three address and wherein the second address comprises a layer two address.

13. The system of claim 11, wherein the at least one ARS node responds to the ARS query message with an error message when the number of ARS Who messages broadcast in response to receiving the ARS query message meets or exceeds the maximum number of reply failures.

14. The system of claim 13, wherein the at least one ARS node updates the lookup table with information received in a response to the ARS Who message.

15. The system of claim 11, wherein the at least one ARS node synchronizes the lookup table with a lookup table of another ARS node.

16. The system of claim 11, wherein the at least one ARS node maintains the lookup table independently.

17. An Address Resolution Service (ARS) node in communication with one or more endpoints, the ARS node comprising:
one or more circuits that respond to an ARS query message issued by the one or more endpoints with a response message that translates a layer three address to a layer two address using a lookup table, wherein the lookup table comprises a reply failures field comprising data describing a maximum number of reply failures the ARS node will accept before responding to the ARS query message with an error message instead of the response message, wherein the one or more circuits will transmit the error message instead of the response message in response to issuing a number of ARS Who messages that meets or exceeds the maximum number of reply failures.

18. The ARS node of claim 17, wherein the one or more circuits maintain the lookup table independent of other lookup tables maintained by other ARS nodes.

19. The ARS node of claim 18, wherein the layer three address is included in the ARS query message, wherein the one or more circuits reference the lookup table for the layer three address, and wherein the one or more circuits include the layer two address in the response message based on the reference to the lookup table.

20. The ARS node of claim 19, wherein the one or more circuits update the lookup table by issuing the ARS Who message on behalf of the one or more endpoints.
